(19) United States
(12) Patent Application Publication
(10) Pub. No.: US 2015/0282901 A1
(43) Pub. Date: Oct. 8, 2015

(54) Maxillary Barrier Membrane

(71) Applicant: Ismael El Khouly Castilla, New York, NY (US)

(72) Inventor: Ismael El Khouly Castilla, New York, NY (US)

(21) Appl. No.: 14/681,314

(22) Filed: Apr. 8, 2015

Related U.S. Application Data
(60) Provisional application No. 61/976,852, filed on Apr. 8, 2014.

(51) Int. Cl. A61C 8/00

(52) U.S. Cl. CPC A61C 8/0092

(57) ABSTRACT

A maxillary barrier membrane is a device that physically supports the elevated schneiderian membrane during a non-grafted sinus-lifting procedure. The device is inserted into an open space formed by creating a lateral bony window at the desired location and elevating the schneiderian membrane. The device is inserted into the open space in between the maxillary sinus floor and the elevated schneiderian membrane to provide support. The device features a sealing membrane that forms a seal around the lateral bony window. An at least one primary supporting member is connected to a rigid base that is embedded into the sealing membrane. The at least one primary supporting member provides a tenting effect to the elevated schneiderian membrane. The at least one primary supporting member may be adjusted and reoriented in order to accommodate the open space.

The current application claims a priority to the U.S. Provisional Patent application Ser. No. 61/976,852 filed on Apr. 8, 2014.

### FIELD OF THE INVENTION

The present invention relates generally to a membrane for use in maxillary sinus elevation procedures. More specifically, the present invention is a barrier membrane that provides structural support for the space in between the maxillary sinus floor and the elevated schneiderian membrane during a non-grafted sinus-lifting procedure.

### BACKGROUND OF THE INVENTION

Dental implants are one of the most common means of replacing missing teeth. Prior to a dental implant procedure, it is often necessary to perform complex surgical procedures in order to ensure that a patient has a sufficient amount of available bone for placing the dental implants. A number of factors may affect the feasibility of these surgical procedures including deficient bone volume, unfavorable bone quality, and increased pneumatization of the bone. In light of these complicating factors, maxillary sinus augmentation may be performed in order to rectify the issues. The lateral window approach is generally regarded as the most clinically predictable approach to maxillary sinus augmentation. The lateral window approach relates generally to the creation of an open space in between the maxillary sinus floor and the elevated schneiderian membrane into which a new bone is allowed to form. The open space is filled with various graft materials in order to maintain space for bone formation. The success of a bone graft is dependent on various factors as well such as the volume of graft material used, the type of bone graft, and the amount of autogenous bone. The success of a dental implant is often contingent on these factors as well as correlation has been shown between the success of a bone graft and the subsequent success of a dental implant.

While bone grafts have previously been viewed as a definite prerequisite prior to maxillary sinus augmentation, it has been shown that such sinus augmentation procedures can be successful with membrane elevation alone. It is possible to utilize a device to support the schneiderian membrane in an elevated position. Methods utilizing venous blood, an absorbable gelatin sponge, platelet-rich plasma, and concentrated growth factors have all been shown to be suitable alternatives to traditional bone grafts. Different devices have been utilized in these procedures to determine if a bone fixation device can provide predictable bone formation. However, conventional support devices often require the use of screws, plates, and other fasteners in order to secure the devices in place. These support devices have been shown to be effective, albeit inconvenient due to increased likelihood of surgical sensitivity, lengthy procedures, trauma, and morbidity.

The present invention is a maxillary barrier membrane that is able to physically support the elevated schneiderian membrane during a non-grafted sinus-lifting procedure.

The present invention provides a tenting effect within the space in between the maxillary sinus floor and the elevated schneiderian membrane, allowing the formation of new bone within the space. The present invention does not require the use of fasteners to secure into place on the maxillary sinus floor. While the present invention is disclosed primarily with respect to maxillary sinus augmentation and similar procedures, the present invention may be adapted for use in additional surgical applications as well.

### BRIEF DESCRIPTION OF THE DRAWINGS

FIG. 1 is a top perspective view of the present invention.

FIG. 2 is a bottom perspective view of the present invention.

FIG. 3 is a top perspective view of the present invention with the at least one primary supporting member orientation adjusted.

FIG. 4 is a bottom perspective view of the present invention with the at least one primary supporting member orientation adjusted.

FIG. 5 is a bottom perspective view of an embodiment of the present invention with only a first primary supporting member and a second primary supporting member.

FIG. 6 is a bottom perspective view of an embodiment of the present invention with only a first primary supporting member and a second primary supporting member, wherein multiple secondary supporting members are positioned adjacent to each other along a single primary supporting member.

FIG. 7 is a bottom perspective view of an embodiment of the present invention with only a first primary supporting member and a second primary supporting member, wherein multiple secondary supporting members are positioned on opposite sides of a single primary supporting member.

FIG. 8 is a side view an embodiment of the present invention with only a first primary supporting member and a second primary supporting member in use on the maxillary sinus membrane supporting the elevated schneiderian membrane and forming a seal around the lateral bony window.

### DETAIL DESCRIPTIONS OF THE INVENTION

All illustrations of the drawings are for the purpose of describing selected versions of the present invention and are not intended to limit the scope of the present invention.

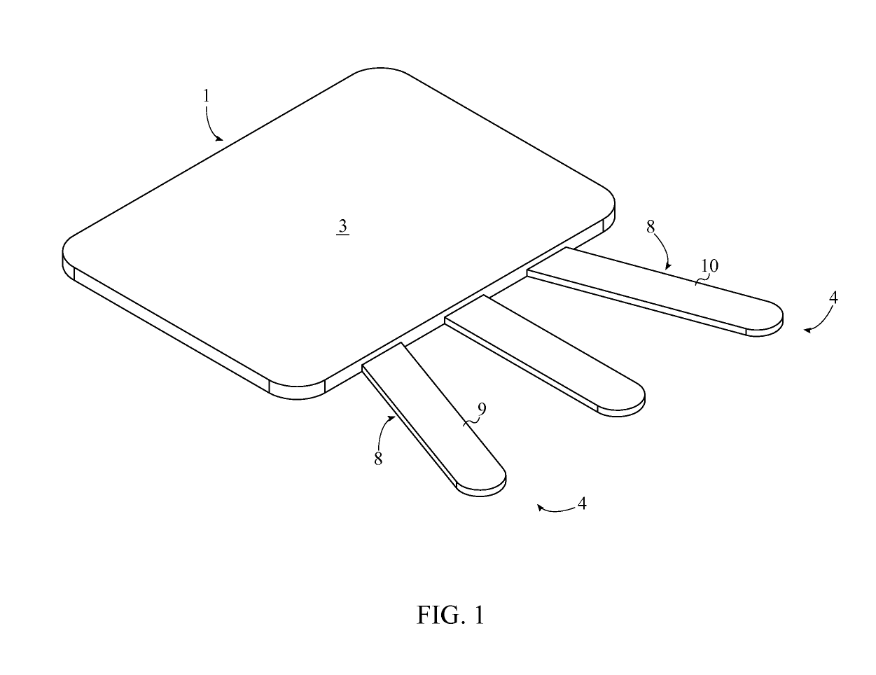

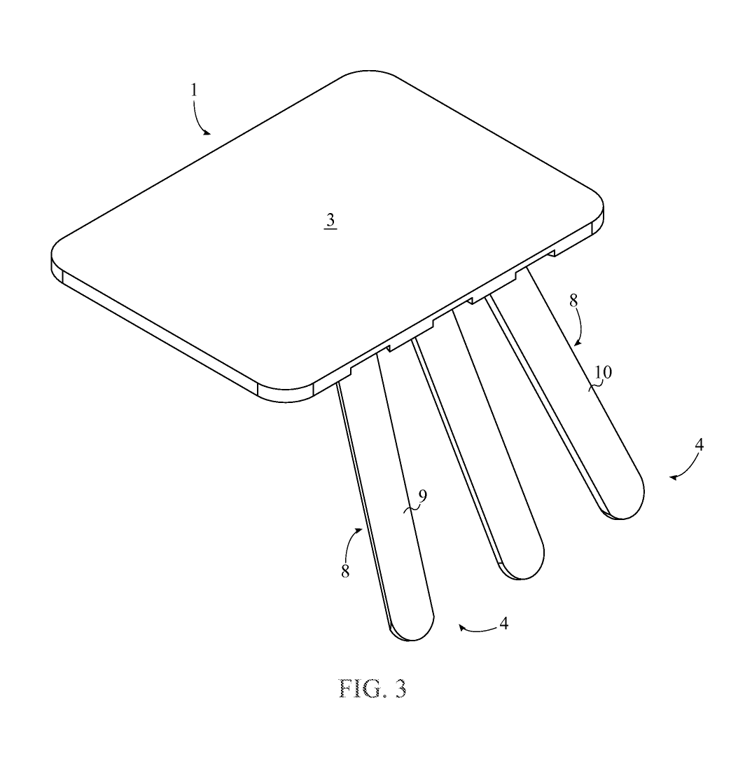

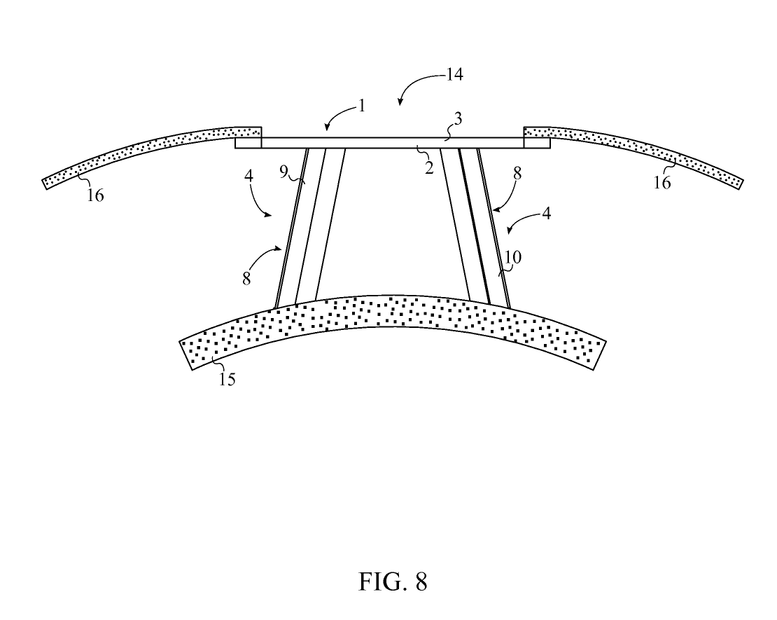

The present invention is a maxillary barrier membrane that is utilized to physically support the elevated schneiderian membrane during a sinus-lifting procedure. Various embodiments of the present invention are shown in FIGS. 1-7 and the present invention is shown in use in FIG. 8. The present invention seeks to eliminate the need for bone grafting prior to a maxillary sinus augmentation. The present invention further reduces the possibility of patient morbidity as the need for a bone graft is eliminated, correspondingly eliminating the need for a secondary surgical site. Additionally, the present invention eliminates the need for screws, plates, and other fasteners when placed on the maxillary sinus floor 15 in support of the elevated schneiderian membrane 16.

With reference to FIGS. 1-4 and FIG. 8, the present invention comprises a sealing membrane 1 and an at least one tenting mechanism 4. In order to reveal and access the schneiderian membrane 16 for elevation, a lateral bony window 14 is created at the desired location. The schneiderian membrane 16 is then elevated in order to create an open space in between the maxillary sinus floor 15 and the elevated schneiderian membrane 16. This open space is then allowed to fill with blood, facilitating the formation of new bone. The sealing membrane 1 is able to form a seal around the lateral bony window 14 in order to retain the blood within the open space. In order to form a seal around the lateral bony window 14, the sealing membrane 1 is preferably approximately a few millimeters larger than the lateral bony window 14. The sealing membrane 1 comprises a setting surface 2 and a bonding surface 3. The setting surface 2 is the surface into which the at least one tenting mechanism 4 is mounted. The bonding surface 3 is the surface that forms a seal around the lateral bony window 14. This seal with the sinus wall is permanent, ensuring that the present invention is securely in place. The setting surface 2 and the bonding surface 3 are positioned opposite to each other through the sealing membrane 1. As such, the setting surface 2 and the bonding surface 3 are opposing surfaces of the sealing membrane 1. In the preferred embodiment of the present invention, the sealing membrane 1 is a composed of collagen or polytetrafluoroethylene (PTFE). However, the present invention is not limited with respect to the specific material of the sealing membrane 1.

The at least one tenting mechanism 4 provides structural support to the sealing membrane 1 and additionally provides support to the elevated schneiderian membrane 16. The at least one tenting mechanism 4 comprises a rigid base 5 and an at least one primary supporting member 8. The rigid base 5 is the portion of the at least one tenting mechanism 4 that provides structural rigidity and support to the sealing membrane 1. As such, the rigid base 5 is embedded into the sealing membrane 1 from the setting surface 2. This allows the rigid base 5 to provide structural support to the sealing membrane 1 without compromising the ability of the sealing membrane 1 to form a seal around the lateral bony window 14. In the preferred embodiment of the present invention, the rigid base 5 is composed of titanium. However, the present invention is not limited with respect to the specific material of the rigid base 5. The at least one primary supporting member 8 is the portion of the at least one tenting mechanism 4 that is able to physically retain the positioning of the elevated schneiderian membrane 16 by providing a tenting effect to the open space in between the maxillary sinus floor 15 and the elevated schneiderian membrane 16. The at least one primary supporting member 8 is preferably composed of titanium. However, like the sealing membrane 1 and the rigid base 5, the present invention is not limited with respect to the specific material of the at least one supporting member 8. The at least one primary supporting member 8 is hingedly connected to the rigid base 5, allowing the orientation of the at least one primary supporting member 8 relative to the rigid base 5 to be adjusted as needed. As such, the orientation angle of the at least one primary supporting member 8 relative to the rigid base 5 may be adjusted in order to achieve the optimal shape for the present invention for the open space. The hinged connection between the at least one primary supporting member 8 and the rigid base 5 may be achieved through various means including, but not limited to, a malleable material for the at least one primary supporting member 8 or various mechanical means.

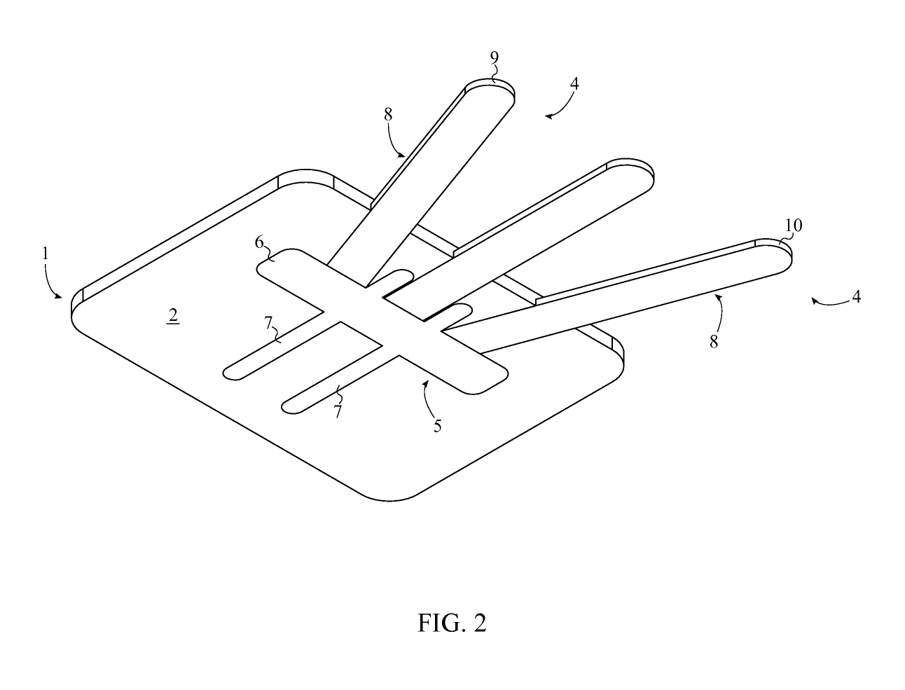

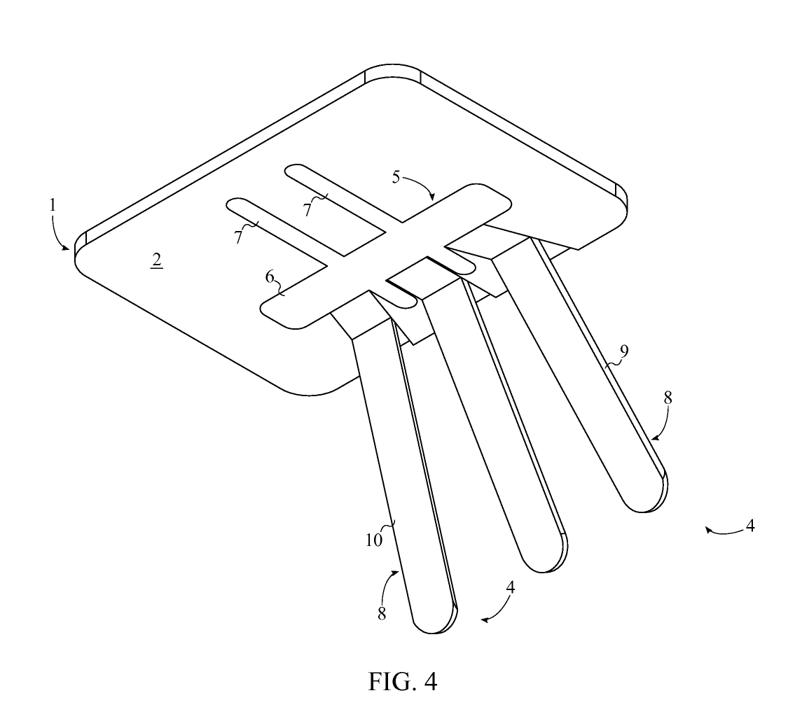

In the embodiment of the present invention shown in FIG. 2 and FIG. 4, the rigid base 5 comprises an elongated base 6 and an at least one branch 7. The elongated base 6 serves as the portion of the rigid base 5 to which the at least one branch 7 is attached. The at least one branch 7 is the portion of the rigid base 5 that extends outward from the elongated base 6. The rigid base 5 in this embodiment of the present invention provides structural rigidity and support over a larger area of the sealing membrane 1 as the at least one branch 7 is able to extend the support provided by the rigid base 5. The at least one branch 7 is laterally positioned to the elongated base 6, allowing the at least one branch 7 to extend outward and provide additional support to the sealing membrane 1.

In the embodiment of the present invention shown in FIGS. 1-4, the at least one primary supporting member 8 comprises a first primary supporting member 9 and a second primary supporting member 10. The first primary supporting member 9 and the second primary supporting member 10 each provide a tenting effect to the open space in between the maxillary sinus floor 15 and the elevated schneiderian membrane 16. The first primary supporting member 9 is offset from the second primary supporting member 10 along the rigid base 5. This allows the first primary supporting member 9 and the second primary supporting member 10 to effectively provide a tenting effect. The embodiment of the present invention shown in FIGS. 1-4 includes an additional primary supporting member in addition to the first primary supporting member 9 and the second primary supporting member 10.

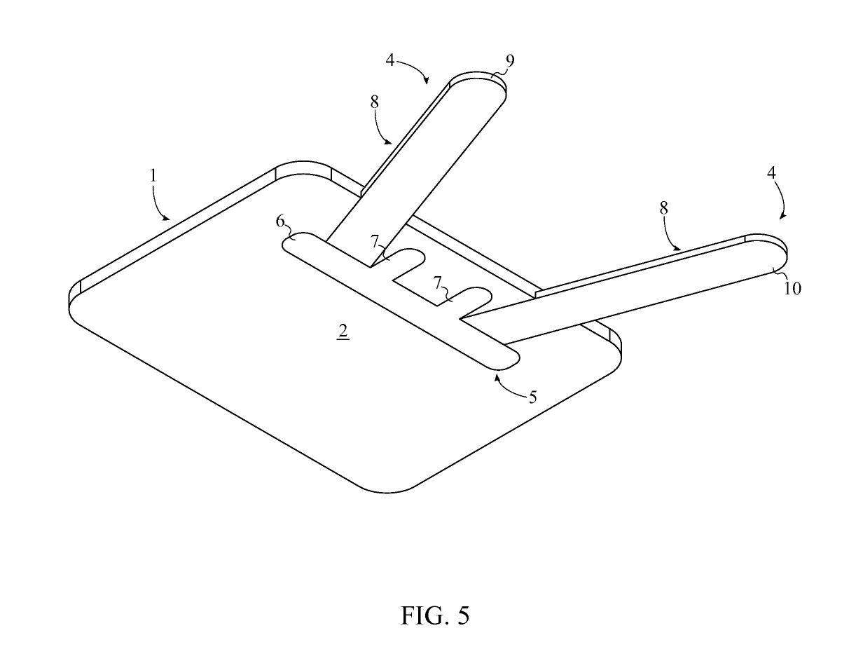

The embodiments of the present invention shown in FIGS. 5-8 are similar to the embodiment of the present invention shown in FIGS. 1-4. However, these embodiments do not include the additional primary supporting member beyond the first primary supporting member 9 and the second primary supporting member 10 shown in FIGS. 1-4. These embodiments of the present invention are functionally the same as the embodiment of the present invention shown in FIGS. 1-4 and may be utilized to accommodate various open spaces in between the maxillary sinus floor 15 and the schneiderian membrane 16.

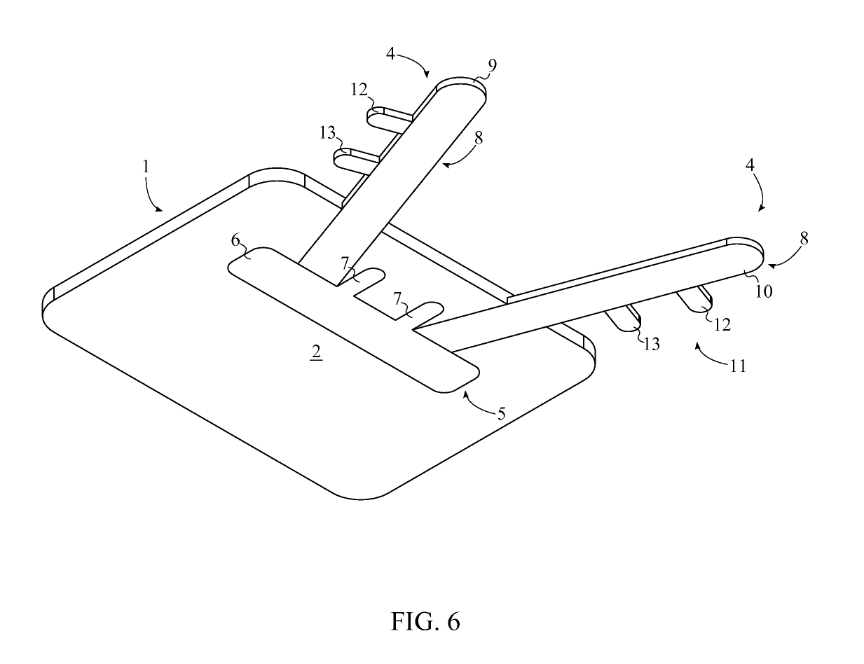

With reference to FIGS. 6-8, the at least one tenting mechanism 4 further comprises an at least one secondary supporting member 11. In the preferred embodiment of the present invention, the at least one secondary supporting member 11 is composed of titanium, although the present invention is not limited with respect to the specific material of the at least one secondary supporting member 11. The at least one secondary supporting member 11 allows the user to further adjust and orient the present invention in order to accommodate the open space in between the maxillary sinus floor 15 and the elevated schneiderian membrane 16. The open space may be additionally shaped and supported as needed by the at least one secondary supporting member 11. Much like the at least one primary supporting member 8, the at least one secondary supporting member 11 is hingedly connected to the at least one primary supporting member 8. This allows the orientation of the at least one secondary supporting member 11 relative to the at least one primary supporting member 8 to be adjusted as needed.

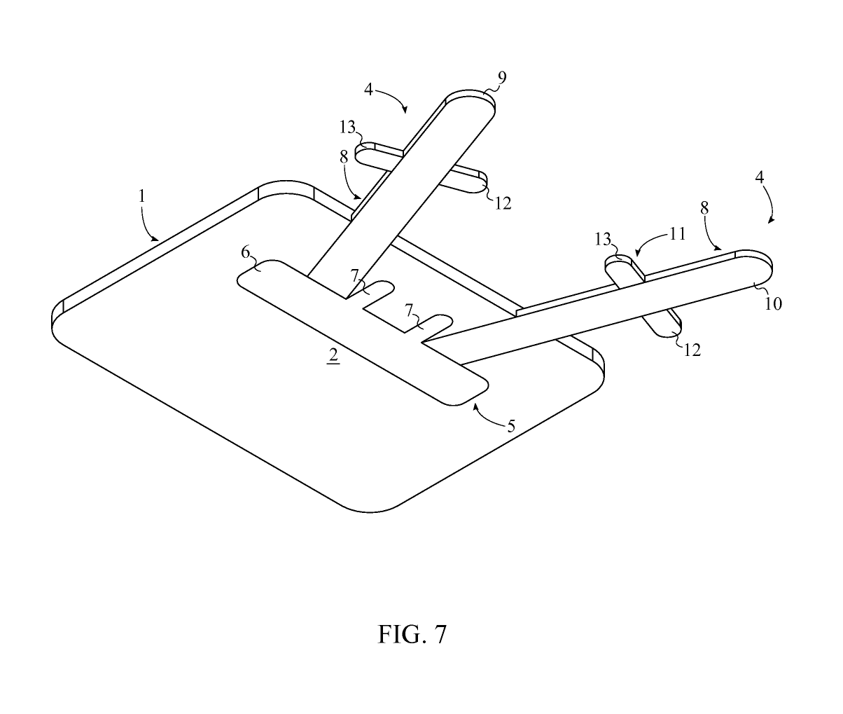

In the embodiments of the present invention shown in FIG. 6-8, the at least one secondary supporting member 11 comprises a first secondary supporting member 12 and a second secondary supporting member 13. The first secondary supporting member 12 and the second secondary supporting member 13 provide additional shaping and supporting potential to the at least one tenting mechanism. In the embodiment of the present invention shown in FIG. 6, the first secondary supporting member 12 and the second secondary supporting member 13 are offset from each other along the at least one primary supporting member 8. In the embodiment of the present invention shown in FIG. 7, the first secondary supporting member 12 and the second secondary supporting member 13 are positioned adjacent to each other about the at least one primary supporting member 8. These two embodiments of the present invention display two different means of positioning the first secondary supporting member 12 and the second secondary supporting member 13 in order to shape and support the open space in between the maxillary sinus floor 15 and the elevated schneiderian membrane 16.

Although the present invention has been explained in relation to its preferred embodiment, it is understood that many other possible modifications and variations can be made without departing from the spirit and scope of the present invention as hereinafter claimed.

What is claimed is:

1. A maxillary barrier membrane comprises:
a sealing membrane;
an at least one tenting mechanism;
the sealing membrane comprises a setting surface and a bonding surface;
the at least one tenting mechanism comprises a rigid base and an at least one primary supporting member;
the setting surface and the bonding surface being positioned opposite to each other through the sealing membrane;
the rigid base being embedded into the sealing membrane from the setting surface; and
the at least one primary supporting member being hingedly connected to the rigid base.

2. The maxillary barrier membrane as claimed in claim 1 further comprises:
the rigid base comprises an elongated base and an at least one branch; and
the at least one branch being laterally positioned to the elongated base.

3. The maxillary barrier membrane as claimed in claim 1 further comprises:
the at least one primary supporting member comprises a first primary supporting member and a second primary supporting member; and
the first primary supporting member being offset from the second primary supporting member along the rigid base.

4. The maxillary barrier membrane as claimed in claim 1 further comprises:
the at least one tenting mechanism further comprises an at least one secondary supporting member; and
the at least one secondary supporting member being hingedly connected to the at least one primary supporting member.

5. The maxillary barrier membrane as claimed in claim 4 further comprises:
the at least one secondary supporting member comprises a first secondary supporting member and a second secondary supporting member; and
the first secondary supporting member and the second secondary supporting member being offset from each other along the at least one primary supporting member.

6. The maxillary barrier membrane as claimed in claim 4 further comprises:
the at least one secondary supporting member comprises a first secondary supporting member and a second secondary supporting member; and
the first secondary supporting member and the second secondary supporting member being positioned adjacent to each other about the at least one primary supporting member.

7. A maxillary barrier membrane comprises:
a sealing membrane;
an at least one tenting mechanism;
the sealing membrane comprises a setting surface and a bonding surface;
the at least one tenting mechanism comprises a rigid base, an at least one primary supporting member, and an at least one secondary supporting member;
the setting surface and the bonding surface being positioned opposite to each other through the sealing membrane;
the rigid base being embedded into the sealing membrane from the setting surface;
the at least one primary supporting member being hingedly connected to the rigid base; and
the at least one secondary supporting member being hingedly connected to the at least one primary supporting member.

8. The maxillary barrier membrane as claimed in claim 7 further comprises:
the rigid base comprises an elongated base and an at least one branch; and
the at least one branch being laterally positioned to the elongated base.

9. The maxillary barrier membrane as claimed in claim 7 further comprises:
the at least one primary supporting member comprises a first primary supporting member and a second primary supporting member; and
the first primary supporting member being offset from the second primary supporting member along the rigid base.

10. The maxillary barrier membrane as claimed in claim 7 further comprises:
the at least one secondary supporting member comprises a first secondary supporting member and a second secondary supporting member; and
the first secondary supporting member and the second secondary supporting member being offset from each other along the at least one primary supporting member.

11. The maxillary barrier membrane as claimed in claim 7 further comprises:
the at least one secondary supporting member comprises a first secondary supporting member and a second secondary supporting member; and
the first secondary supporting member and the second secondary supporting member being positioned adjacent to each other about the at least one primary supporting member.

12. A maxillary barrier membrane comprises:
a sealing membrane;
an at least one tenting mechanism;
the sealing membrane comprises a setting surface and a bonding surface;
the at least one tenting mechanism comprises a rigid base, an at least one primary supporting member, and an at least one secondary supporting member;
the rigid base comprises an elongated base and an at least one branch;
the setting surface and the bonding surface being positioned opposite to each other through the sealing membrane;
the rigid base being embedded into the sealing membrane from the setting surface;
the at least one primary supporting member being hingedly connected to the rigid base;
the at least one branch being laterally positioned to the elongated base; and
the at least one secondary supporting member being hingedly connected to the at least one primary supporting member.

13. The maxillary barrier membrane as claimed in claim 12 further comprises:
the at least one primary supporting member comprises a first primary supporting member and a second primary supporting member; and
the first primary supporting member being offset from the second primary supporting member along the rigid base.

14. The maxillary barrier membrane as claimed in claim 12 further comprises:
the at least one secondary supporting member comprises a first secondary supporting member and a second secondary supporting member; and
the first secondary supporting member and the second secondary supporting member being offset from each other along the at least one primary supporting member.

15. The maxillary barrier membrane as claimed in claim 12 further comprises:
the at least one secondary supporting member comprises a first secondary supporting member and a second secondary supporting member; and
the first secondary supporting member and the second secondary supporting member being positioned adjacent to each other about the at least one primary supporting member.
